(19) United States
(12) Patent Application Publication
(10) Pub. No.: US 2021/0179231 A1
(43) Pub. Date: Jun. 17, 2021

(54) ADJUSTABLE TETHER SYSTEM AND METHOD

(71) Applicant: Terry Pimental, Modesto, CA (US)

(72) Inventor: Terry Pimental, Modesto, CA (US)

(21) Appl. No.: 17/125,877

(22) Filed: Dec. 17, 2020

Related U.S. Application Data
(60) Provisional application No. 62/949,415, filed on Dec. 17, 2019.

(51) Int. Cl. B63B 21/20; B60P 7/08

(52) U.S. Cl. CPC B63B 21/20; B63B 2021/203; B60P 7/0823

(57) ABSTRACT

An adjustable tether system and method for operating same, the system comprises first and second straps movable connected together by a length adjustment device that adjusts the overall length of the system, first strap has one first strap end that supports a first attachment device and second first strap end fixedly attached to the length adjustment device, the second strap has one second strap end movably inserted into the length adjustment device and other second strap end supporting a second attachment device, wherein for one embodiment, the attachment device removably connects to a vehicle such as a boat while other second attachment device removably connects to an object that is not the vehicle.

### CROSS-REFERENCES TO RELATED APPLICATIONS

The Applicant claims priority to and incorporates by reference the US Provisional patent application entitled ADJUSTABLE TETHER SYSTEM AND METHOD, Ser. No. 62/949,415, filed on Dec. 17, 2019.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention may relate to adjustable tether systems that may be used to removably attach one object like as a vehicle, namely a boat, to another object such a boat fender, dock, boat trailer and alike. More particularity to those tether systems whose tethers that may be adjustable in overall length and may further utilize a quick length adjustment device for such adjustment.

### BACKGROUND

One of the greater challenges to operating a boat, whether sail or motor-powered, is generally to safely bring the boat in and moor the boat to a dock or other mooring device in a manner that does not result to damage to the boat which can be expensive to repair. The dock, generally made of much sturdier construction and materials than most boats, can damage the boat upon rough or repeated boat hull contact. The resulting hull damage could allow water penetration of the boat hull, seriously impairing the boat's floatation capability.

To generally ameliorate such docking damage, a boat could be equipped with one or more boat fenders, generally a cylindrically-shape cushioning device made of substantially resilient material used go between the dock's boat contacting surface and the boat hull to limit the boat-dock impact upon mooring (or leaving the dock.) The boat fender may be further connected to one end of a tether (e.g., rope, strap, cord or alike) to generally allow the other end of the tether (and hence the boat fender) to be removably connected to a part of the boat structure or fixture like a railing, cleat or alike. This attachment could allow the boat fender to be placed overboard and come to rest against the hull. By adjusting the length of the tether, the boat fender may be appropriately draped alongside the boat hull to a point where the dock could otherwise contact the hull.

One possible issue with such docking procedure could arise if only one person is handling the boat. In such a situation, that person could easily find himself or herself doing several mooring tasks things at once. A daunting array of tasks if the boat is under sail coming to the dock. One such combined mooring task could be taking the one or more boat fenders from the on-boat storage area (e.g., cockpit, cabin, boat storage compartment or the like); generally securing the boat fender(s) via associated tether(s) to the boat structure and then substantially place the one or more such boat fenders over the side (e.g., against the boat hull exterior) in anticipation of where the dock may possibly contact the boat hull. The tether lengths may then have to be adjusted at the same time to generally prevent the boat fender from being located too high or too low upon the hull and being unable to prevent dock contact with the boat. This tether length adjustment, when done with several tethered boat fenders, may overwhelm the person attempting to dock the boat. What could be needed is a tether system or method that allows quick, removable and adjustable attachment of a boat fender to the boat structure. This tethering system could be additionally be adapted to removably attach a boat to another other vehicle, such as a boat trailer or to a mooring device such as a dock, floating mooring buoy or the alike.

One possible solution could be an adjustable tether system comprising of a long strap having made of suitable material (e.g., rope, cord, strap, and alike) terminating in two ends, one strap end may form a folded loop while the other strap end passes into and through an adjustment device (such as a cam clamp, ratchet and alike) to be used to adjust the tether's overall operating length. The one strap end can be used to removably attach the adjustable tether to another object such as the boat fender, other like.

In at least one version of the invention, the quick length adjustment device could feature a protective coating to prevent the adjustment device from scratching or otherwise damaging surfaces of items in proximity to the adjustable tether. The quick length adjustment device can further feature an attachment device for removably attaching the other end of the adjustable tether to a vehicle like a boat. The attachment device in one embodiment could be a clipped S-hook fixedly connected to the adjustment device by a second strap.

In operation, the one looped end may pass into and through a portion of an object (e.g., a securing aperture formed by one end of a boat fender, etc.) while the quick length attachment device be brought to be passed into and through the passed through formed loop to generally tighten the attachment of the strap loop end to the said object. The quick length adjustment device may be then activated by moving a length of the first strap through the quick adjustment device to adjust the overall tether operating length. This tether length adjustment may be done to place the boat fender at the right height along the side of the boat to meet the side of the dock; to bring a boat close to a dock, to tighten a boat down upon a boat trailer, to tighten an object, such a float board, onto an SUV rook rack or the like. The attachment device may then be attached to an appropriate fixture of the vehicle (e.g., boat railing or cleat, SUV roof rack or the like) to connect the remaining portion of the tether to the vehicle. In this manner, the tether length adjustment, attachment of the tether to a vehicle, object or both and alike can be done easily and quickly by one operator as needed. Conversely, once the object is to be removed from the tether, this can also be done quickly by one operator as well.

For example, when a boat is underway away from a dock, the tether system can be easily and quickly removed by one person from the boat structure to allow the adjustable tether and attached object to be otherwise placed onboard in a suitable on boat storage area. The same adjustable tether could be released from the boat fender and be used later to removably secure the boat to a trailer, the looped end being connected to a boat cleat while the attachment device removably connects to a portion of the trailer structure. Similarly, the adjustable tether could also be used to removably secure articles (e.g., surf boards, body boards and alike) to other vehicles like sport utility vehicle (SUV) via a roof rack.

Further, another version of the invention could be used to removably secure a boat to a dock. In this version, the attachment device may be a second strap with a second strap loop end with another other second strap end fixedly attach to the quick length adjustment device. The second strap loop end could be removably attached/looped over a vehicle attachment fixture (e.g., a boat cleat or like) while the first strap's loop end may be looped over an object's attachment fixture (e.g., a dock cleat.) As the boat is brought proximate to dock, the quick length adjustment device can be used to pull though the first strap to take the slack out of the adjustable tether to generally limit the capacity of the boat to bang into the dock possibly resulting in damage to the boat.

### SUMMARY OF ONE EMBODIMENT OF THE INVENTION

### Advantages of One or More Embodiments of the Present Invention

The various embodiments of the present invention may, but do not necessarily, achieve one or more of the following advantages:

to provide a tether system means that may be quickly adjusted and attached by one operator to removably connect a boat fender to a boat, a boat to a boat trailer, a boat to a dock and an article or object to a vehicle;

to provide a tether system that can be quickly adjusted by one operator to attach a boat fender to a boat structure and locate the boat fender properly alongside the boat;

the ability to adjust and attach a mooring tether system quickly and easily to moor a boat alongside a dock or other mooring device;

to provide a tether system that utilizes a coating placed upon quick length adjustment device to reduce possible object damage caused by the quick length adjustment device coming in contact with said object;

the ability to thread a portion of tether though a quick length adjustment device to adjust the operating length of the tether;

provide a boat fender positioning system that is easily and quickly operated by one person; and

the ability to quickly and easily adjust a tether system to secure an object to a vehicle.

These and other advantages may be realized by reference to the remaining portions of the specification, claims, and abstract.

### BRIEF DESCRIPTION OF ONE EMBODIMENT OF THE PRESENT INVENTION

One possible embodiment of the present invention could comprise an adjustable tether system, an adjustable tether having a definite length of material having two ends, one end removably connected to an attachment point on the boat fender, the other end is passed through an attachment device used to adjust the operating overall length of the adjustable tether, the attachment device could further support a protective coating, the attachment device could further feature an attachment device used to removably attach the tether to a vehicle.

Another possible embodiment of the present invention could be an adjustable tether for a boat fender comprising a definite length of material having two ends, the first end is constructed to reversibly attach to a boat fender while the second end is movably threaded through an quick length adjustment device that adjusts the operating length of the tether, the quick length adjustment device further comprising an attachment device that removably attaches the adjustable tether to a structure of a vehicle.

Still yet another possible embodiment of the present invention could be a method for using the present invention comprising, providing an adjustable boat tether, the tether comprising first strap and a second strap, each strap terminating in two ends, the one strap end is loop configured to removably connected to boat fixture while the other one strap end is movably threaded through an quick length adjustment device; the adjusting device movably receives a one second strap end to change the overall length of the tether; the other second strap end forms a loop for removably attachment to a dock.

Yet another further possible embodiment of the present invention could be a method for using the present invention comprising, providing an adjustable tether, the adjustable tether comprising a definite length of material having two ends, the first end is loop configured to removably connected to a vehicle in a first position while the second end is movably threaded through an quick length adjustment device to change the overall length of the tether; the quick length adjustment device having an attachment device that can removable attach to the vehicle at a second position, activating the quick length adjustment device to bring length of material against an article to removably and securing article to the vehicle.

The above description sets forth, rather broadly, a summary of one embodiment of the present invention so that the detailed description that follows may be better understood and contributions of the present invention to the art may be better appreciated.

Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of the present invention.

FIG. 2 is substantially a perspective view of one embodiment of attachment device of the present invention.

FIG. 3 is substantially a perspective view of another embodiment of attachment device of the present invention.

FIG. 4 is substantially a perspective view of yet another embodiment of attachment device of the present invention.

FIG. 5 is substantially a perspective cutaway view of the quick length adjustment device of the present invention.

FIG. 6 is substantially a perspective view of the quick length adjustment device of the present invention.

FIG. 7 is substantially a perspective view of one embodiment of invention being attached to a boat fender.

FIG. 7A is substantially another perspective view of one embodiment of invention being attached to a boat fender.

FIG. 7B is substantially another perspective view of one embodiment of present invention being attached to a boat fender.

FIG. 8 is substantially a perspective view of one embodiment of present invention being attached to a motor vehicle.

FIG. 9 is substantially a perspective view of one embodiment of the present invention attaching to the boat to a trailer.

FIG. 10 is substantially a perspective view of one embodiment of invention being attaching a boat to a dock.

FIG. 11 is a schematic showing one embodiment of a process or method for operating the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

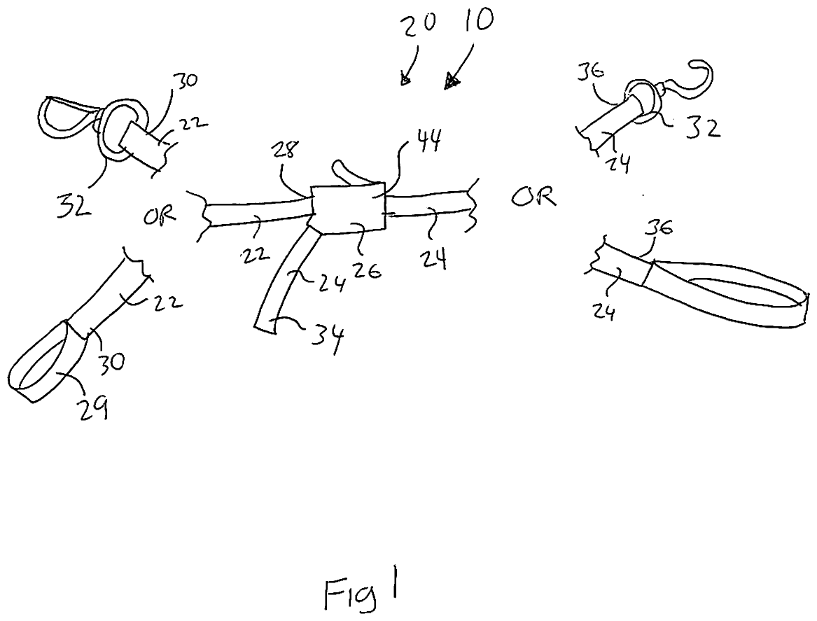

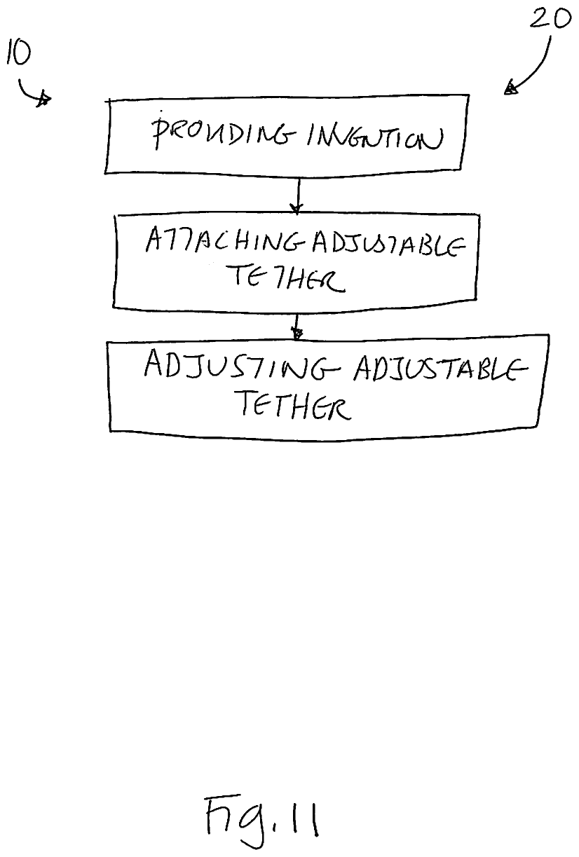

As substantially shown in FIGS. 1 and 11, the present invention 10 could comprise an adjustable tether 20 for attaching an object such a boat fender to a vehicle such as a boat; attaching a vehicle such as a boat to structure such as a dock; attaching a vehicle such as boat to another vehicle such as boat trailer and the like; as well as a method or process 100 for using adjustable tether. As substantially shown in FIG. 1, one possible embodiment of the adjustable tether could comprise of two straps, a first strap 22 and a second strap 24, moveably connect to one another by a quick length adjustment device 26 that is used to adjust the overall operating length of the adjustable tether 20. The first strap 22 could comprise one first strap end 28 that fixedly attaches to the quick length adjustment device while the other first strap end 30 could be configured to be removably attached to a vehicle fixture (such as boat cleat, railing or alike.) In at least one embodiment, the other first strap end 30 further comprises to an attachment device 32 (e.g., an S-hook with spring clasp, forms a first loop 29) The straps 22, 24 themselves could be made of wide variety of materials and suitable construction to meet their purpose known in the field.

In another version of the invention 10, the first strap 22 forms a first loop 29 suitable for removable attachment to vehicle (e.g., boat) fixture such a cleat, railing and the like. The second strap 24 terminating in one second strap end 34 and other second strap end 36. The one second strap end 34 could pass through and could be movably held by the quick length adjustment device 26 while the one second strap end 36 could form a second loop 38 to be used for attachment purposes.

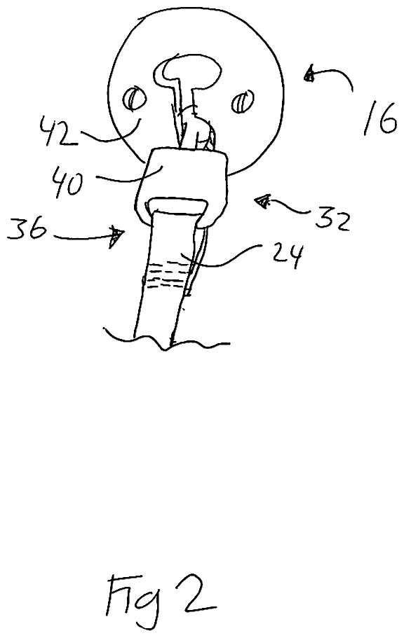

In another embodiment, as substantially shown in FIG. 2, the other second strap end 36 does not form a second loop 38 and instead supports another attachment device 32 comprising o a securing lock 40 (e.g., eye snap mounts) that removably mount to a securing lock base 42 (e.g., eye snap base) that may be affixed to the boat structure (e.g., via fasteners.) The eye snap could feature an eyelet that removably attaches the eye snap to the other second strap end 36. The eye snap could further feature a protrusion that removably engages the eye snap base (e.g., that could be mounted to the boat).

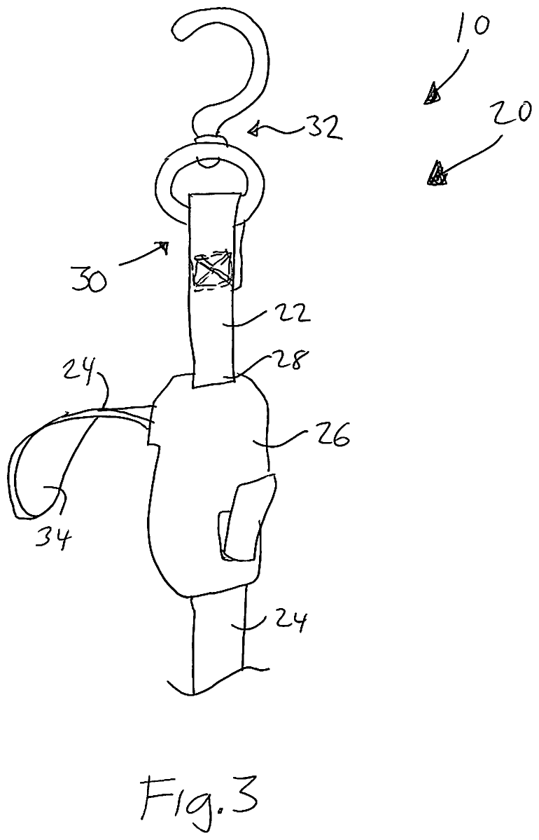

As substantially shown in FIG. 3, the attachment device 32 (e.g., for first strap 22, second strap 22 or both straps) in another version could be an open hook with eyelet with fixedly connected to respective strap end.

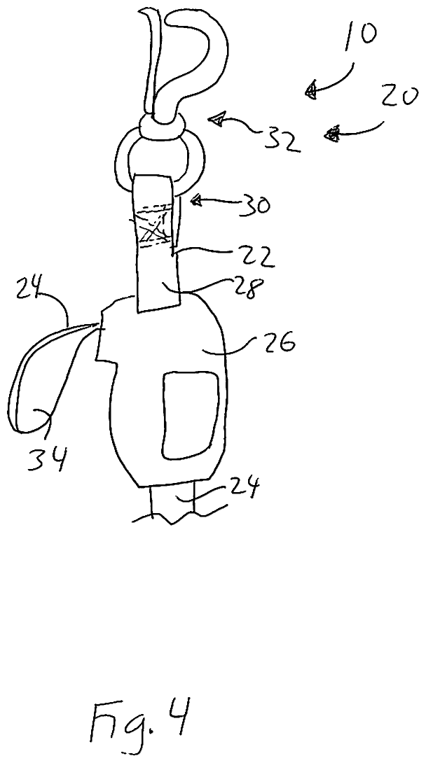

As substantially shown in FIG. 4, another embodiment of the attachment device 32 could be an eyelet hook with a spring lever to removably enclosed the otherwise open portion of the hook that could clip over a (boat) structure such as a railing or like. With either type of S-hook, the strap can be looped around the eyelet portion of the hook and sewn together to fixedly attach the hook to the respective strap.

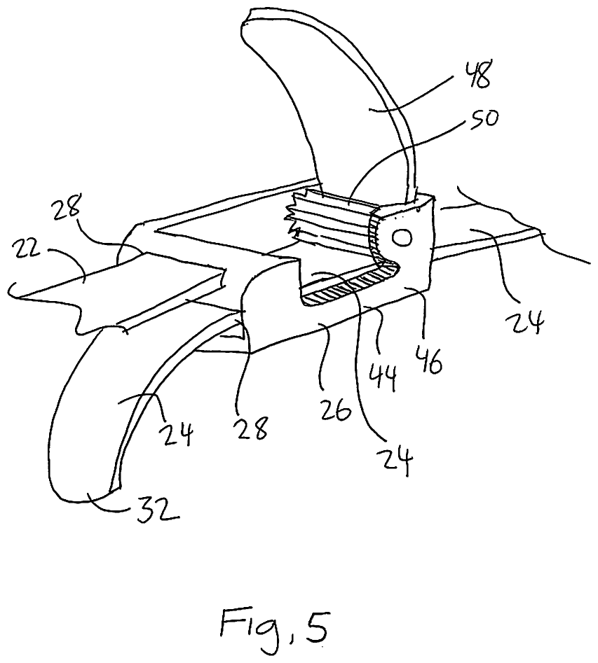

The quick length adjustment device 26 can be made from a suitable material such metal, plastic or combination of both. The quick length adjustment device 26 could one of variety of clamps 44 that can be removably hold a strap inserted and passed through the clamp 44. Deactivation of such a clamp 44 to release the inserted strap could occur with moving a lever to rotate a cam out of contact with the inserted second strap 24; depressing a button to release engaging clamp surfaces from the inserted second strap 24; and the like In one version, as substantially shown in FIG. 5, the cam-operated clamp could be could have a U-shaped clamp body 46 having a flat base with raised sides. The cam end 50 of a lever 48 could be pivotally held between the arms so that a spring-biased rotation of the lever 48 would bring the cam end 50 of the lever 48 down into closer proximity with the flat base of the clamp body. The cam end 50 could feature ridged, serrated or other rough surfaces that when in contact with the second strap 24 held between the lever 48 and the clamp body 46 would removably secure the second strap 24 in place within the quick length adjustment device 26. Lifting the non-cam end of the lever 48 away from the flat base would rotate the cam end 50 out of engagement with the second strap 24 to allow movement of the second strap 24 between the cam end 50 and the flat base of the clamp body 46. Said lifting of the non-cam end of the lever 48 could allow for adjustment to the overall length of the adjustable tether 20 while lowering of the non-cam end could engage the second strap 24 to the clamp body 46 to establish the desired overall length of the adjustable tether 20. Generally, a spring bias (not shown) upon the lever 48/cam 50 could only allow the second strap 24 to be pulled in one direction through the quick length adjustment device 26 when the cam 50 is applied to the second strap 24. The spring bias otherwise would keep the cam end 50 positioned in a manner that prevents the movement of the second strap 24 in a reverse direction unless the lever 48 is lifted to bring the cam end 50 out of contact with the second strap 24.

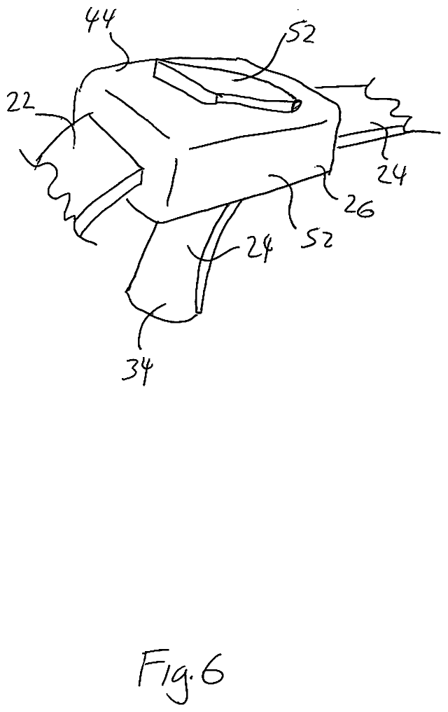

As substantially shown in FIG. 6, in at least one embodiment, the quick length adjustment device 26 could have a body with a polymer (e.g., rubber, plastic, or the like) protective coating 52 at least partially applied to exterior surface of the metal body to prevent the quick length adjustment device from generally damaging surfaces of objects (e.g., vehicle) to which the adjustable tether 20 may be attached to or otherwise may come in contact. This protective coating may be applied to the edges of the body as well as non-cam portion of the lever.

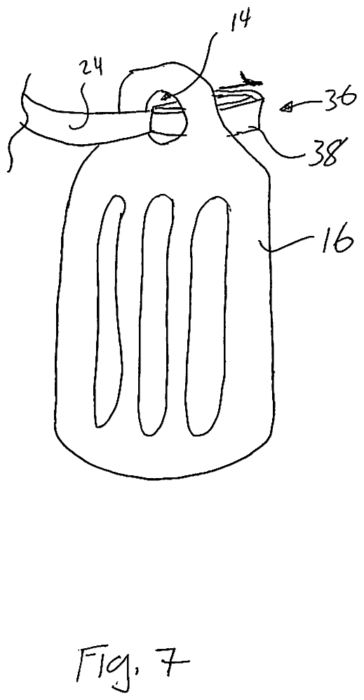

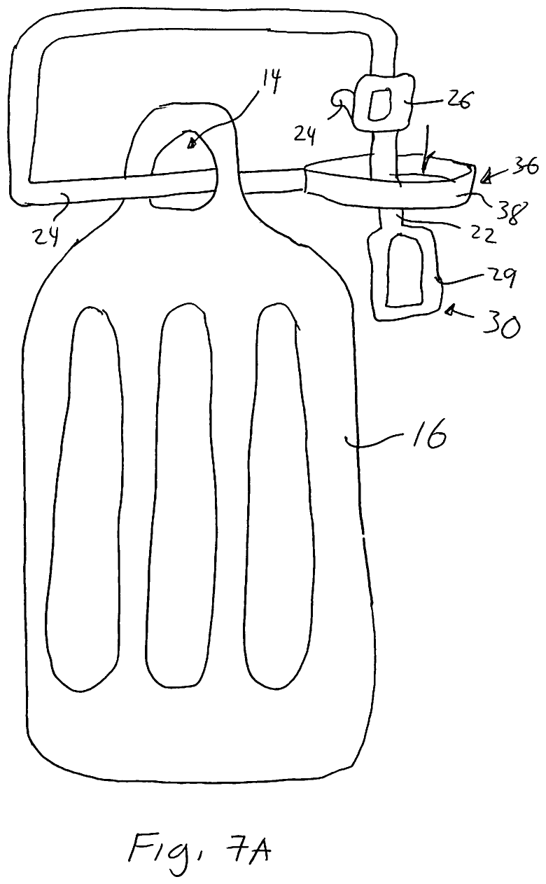

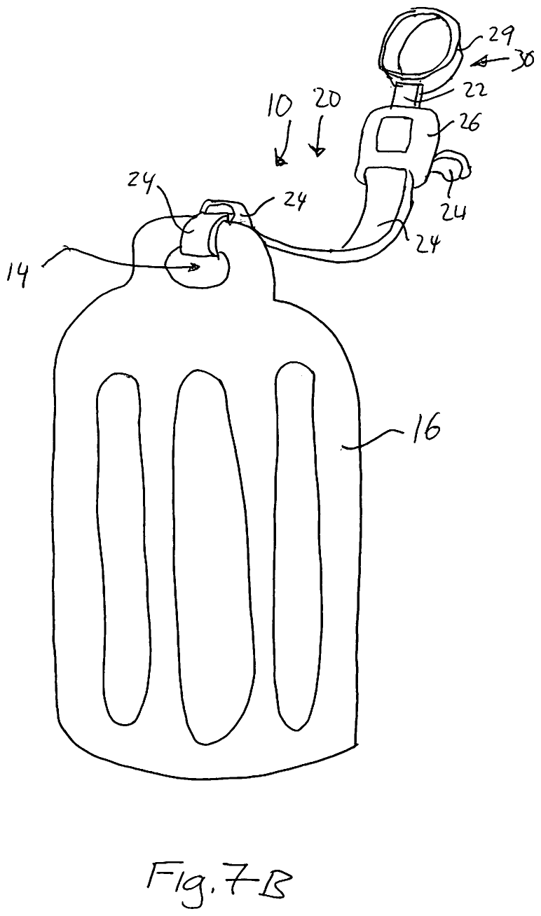

As substantially shown in FIGS. 1 and 7-7B, another embodiment of the invention 10 could have the other second strap end 36 having a respective attachment device 32 forming a second loop 38 that is placed into and through an attachment aperture 14 formed by an object (e.g., an end of the boat fender 12) that is to be removably attached to the second strap 24. The other first strap end 30 may then be fed through the open second loop 38 to tighten down the other second strap end 36 upon the object (e.g., boat fender 12.) The other first strap end 30 then can be suitably and removably attached to the vehicle (e.g., a handrail or other boat attachment fixture). In one version, an attachment device 32 of the other first strap end 30 such as a S-hook (with spring lever) may removably engage the vehicle or like. The overall length of the adjustable tether 20 (e.g., the height of the fender/bumper alongside the outside of the boat hull) can be adjusted by moving second strap 24 relative to quick length adjustment device 26 to set the overall adjustable tether length. In this manner, the invention 10 could be a quick means for mounting and adjusting objects (e.g., boat fenders/bumpers) to vehicles (e.g., boats) in that both attachment and adjustment could be accomplished within a few seconds by one person.

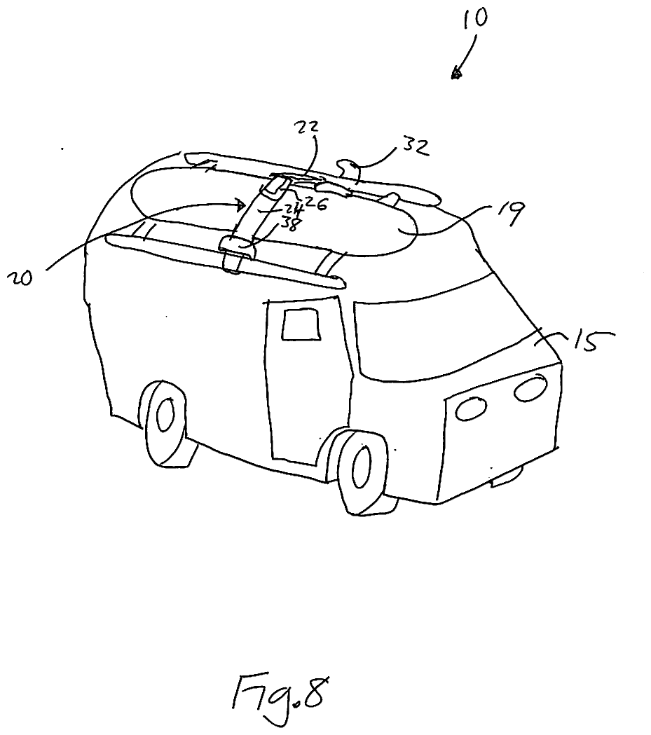

As substantially shown in FIGS. 1 and 8, the adjustable tether 20 may further be used also be used as a securing means or device to reversibly attach objects such as float boards, surfboards, kayaks, paddle boards 19, and alike to a vehicle like to a boat, a motor vehicle 15, trailer and alike. In such a configuration, the adjustable tether 20 may be attached to a vehicle (e.g., SUV) roof rack by inserting the other second strap end 36 (e.g., second loop 38) into a space in the one side of the roof rack and then passing the other first strap end 30 through the second loop end 38 to removably attach the other second strap end 36/second loop 38 down upon the one side of the vehicle roof rack. Once the adjustable tether 20 is so anchored to the one side of the vehicle roof rack, the remaining portion of the adjustable tether 20 may be bought over the object (e.g., float board, body board, paddle board, kayak, canoe, surfboard, etc.) placed upon the vehicle roof rack. The attachment device 32 may then brought over to removably attached (e.g., S-Hook is clipped onto) the other side of the vehicle roof rack. The quick length adjustment device 26 can be used (e.g., the second strap 24 is further pulled through the clamp 44) to allow adjustable tether's overall length to be adjusted to desired length (e.g., to be taut in holding the object to the rack). This process may further impart tension upon the object that retains the object upon the SUV roof during transport of the object.

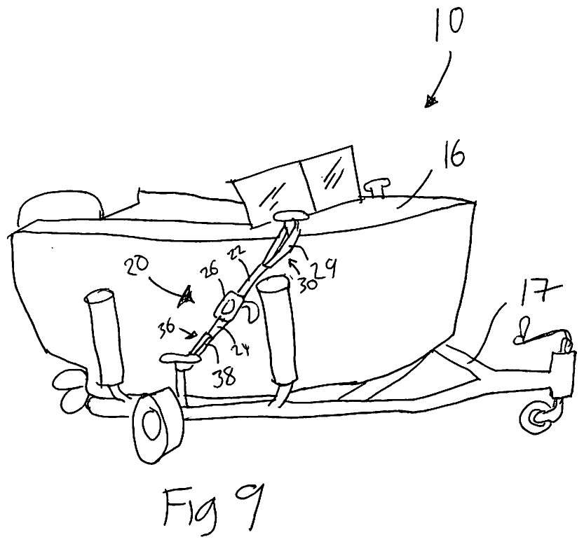

As substantially shown in FIG. 9, one version of the adjustable tether 20 may be used to removable secure a boat 16 to a trailer 17.

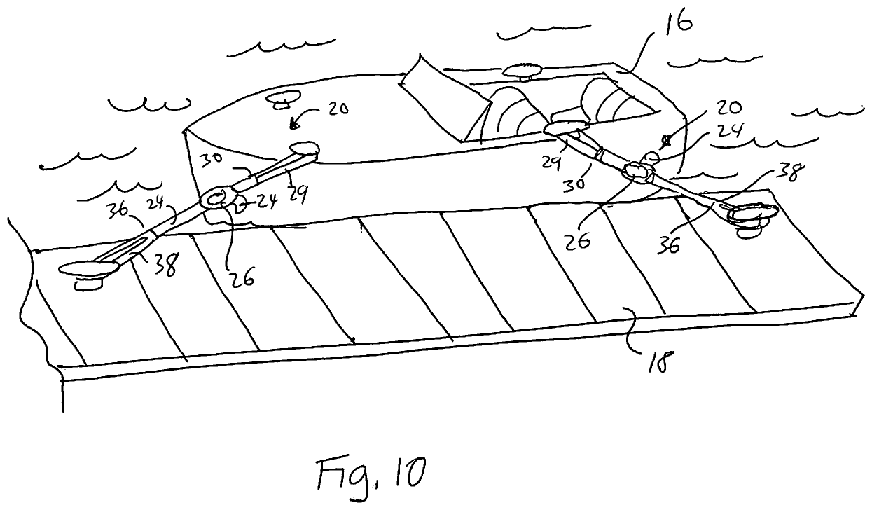

As substantially shown in FIGS. 1, 5 and 10, another version of the adjustable tether system could removably connect a boat to dock 18 or to other suitable mooring implement (e.g., docking buoy—not shown). Such a tether system could comprise of first strap 22 and second strap 24 of respective definite lengths of material (e.g., rope, cord, strap, and alike) with each strap having two respective ends and be adjustably connected by the quick length adjustment device to set the overall length of the adjustable tether. The first strap 22 at one first strap end 28 can be fixedly connected to the quick length adjustable device 26 with the other first strap end 30 being folded over and attached to form first loop 29. The first loop 29 could be configured to removably attach to a boat or dock fixture. In another version, the other first strap end 30 could be fixed attached to an attachment device 32 such as a clipped S-hook with eyelet (e.g., for attaching the adjustable tether 20 to a boat railing, cleat and alike.)

The second strap at the other second strap end could also be folded over to form a second loop 38 while the one second strap end 34 remains open to allow easy insertion into the quick length adjustment device 26 (e.g., the one second strap open end is placed into and through a space formed between the lever cam 50 and the clamp body 46.) Lever cam end can be pivotally attached to the clamp body 46 in a manner to be bias the lever cam end closed upon the clamp body 46 so that the serrated or rough port of the cam end engages a portion of the second strap 24 to removably and adjustably hold the second strap 24 in contact against both the clamp body 50 and cam end 50. The second loop 38 can be placed over a fixture of either a vehicle (e.g., boat) or dock 18 to complete the securing.

Method of Use

As substantially shown in FIG. 11, one possible embodiment of the invention could be a method or process 100 of using the invention 10. The process 100 could start with step 102 providing the invention. In this step, a suitable object (e.g., boat fender) to which the adjustable tether could be attached could be obtained. In one version, the object could be a davit of a dock to which a boat is being brought to dock. The adjustable tether could comprise a two straps movable connected by a quick length adjustment device. Each strap could terminate at two respective two ends. One first strap end may be fed into a quick length adjustment device while the other first strap end may be fixedly attached to the attachment device or otherwise form a first loop. The attachment device or first loop could removably attach the adjustable tether to a structure or fixture (e.g., a cleat, railing attachment or alike) of a vehicle such as a boat. One second strap end could be formed into a loop or be attached to second attachment device. The other second strap end engages the quick length adjustment device.

The second loop/second attachment device could be removably attached to a boat fender. In one instance, the second loop could pass through an attachment aperture formed by one end of the boat fender. The other first end adjustment device could be passed through second loop to removably secure the other second strap end to the boat fender.

In one possible embodiment, the attachment device could be a push button clamp or cam clamp that may be spring-biased to a closed or locked position. In another possible embodiment, the attachment device loop formed form the end of the first strap that is not attached to the adjustment mechanism.

As this step is substantially completed, the process could proceed to step 104, attaching the adjustable tether to the vehicle.

In step 104, attaching the adjustable tether to the vehicle, which in one embodiment could be a boat to which the boat fender is being attached (or to which the davit of a dock or pier is being attached). In one version the boat could be underway and approaching a dock. The operator can then removably affix the adjustable tether (e.g., an attachment device or formed loop) to boat structure to prepare the boat for docking. In one embodiment, the attachment device could be an eye snap that is removably attached to the respective eye snap base permanently affixed to a boat structure. In another embodiment, a plain hook or clipped S-hook may be the attaching device, wherein the hook may removably applied to suitable boat structure such as a railing or cleat. In yet another embodiment, one end of the adjustable tether (e.g., the other first strap end could form a first loop, wherein the first loop may removably applied to suitable boat structure such as a railing or cleat.

In the version of the invention for attaching the boat fender to the boat, the boat fender could be attached to the other second strap end prior to the removable attachment of the adjustable tether to the boat. For this version, the other second strap end could be inserted through aperture formed by one end of the boat fender. The other first end strap could then be inserted and pulled through the second loop to bring the second loop tant and secured upon the boat fender end. In other versions, attachment device connected to other second strap end or formed second loop could be used to removably attach the other second strap end to the boat fender or other desired object.

In the version of the invention for attaching the boat to a mooring device, such as a pier or docking buoy or other vehicle, the other second strap end, generally as the second loop, could be removably secured to the mooring device as the boat comes proximate to said device. This could include applying the second formed loop to a davit, cleat of alike of the pier.

As this step is substantially completed, the process could proceed to step 106, adjusting and positioning the adjustable tether.

In step 106, adjusting and positioning the adjustable tether, the operator could activate the attachment device, moving the lever or button to allow for a free movement of the second strap in one direction relative to the attachment device (e.g., increasing the overall length of the adjustable tether.) Otherwise, the operator could pull more second strap through the quick length adjustment device to either lengthen or shorten the overall length of the adjustable tether. Generally, this adjustment could be done very quickly and possibly one-handed by a single operator. Once the length is adjusted, the boat fender can be placed over the boat side along the desired position on the hull.

Similarly, for tethering the boat to a dock, this same kind of length adjustment could be preformed to take slack out of the adjustable tether so to hold the boat securing against the dock to generally prevent the boat from banging against the dock due to wave, wind or other action.

To remove the adjustable tether, the above steps could be done in reverse order.

### CONCLUSION

Although the description above contains many specifications, these specifications should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. An adjustable tether system that comprises:
(A) a first strap and second strap movably connected together by a length adjustment device that adjusts the overall length of the adjustable tether system;
(B) first strap has one first strap end that supports a first attachment device and other first strap end that connects to the length adjustment device;
(C) second strap has one second strap end that passes into and is movably held by the length adjustment device and other second strap end supports a second attachment device;
wherein the first attachment device is configured to removably attach to a boat, the second attachment device is removably attached an object to be connected to the boat.

2. The adjustable tether system of claim 1 wherein first attachment device is a first loop made from folding the other first strap end.

3. The adjustable tether system of claim 2 wherein the second attachment device is a second loop that is different from the first loop.

4. The adjustable tether system of claim 1 wherein the object is an object from a set of objects consisting a boat fender, a dock, a motorized automotive vehicle, a trailer.

5. A process of operating an adjustable tether system to connect a boat to a boat fender comprising the following steps:
(A) providing an adjustable tether system, the adjustable tether system comprises a first and second strap movable connected together by a length adjustment device that adjusts the overall length of the adjustable tether system, first strap has one first strap end that supports a first attachment device and a second first strap end fixedly attached to the length adjustment device, the second strap has one second strap end that passes into and is movably held by the length adjustment device and other second strap end that supports a second attachment device, wherein the first attachment device is configured to removably connect to the boat while second attachment device is configured to removably connect to the boat fender.
(B) providing a boat;
(C) providing a boat fender;
(D) removably connecting second attachment device to the boat fender;
(E) removably connecting the first attachment device to the boat; and
(F) setting the desired length of the adjustable tether system by using the length adjustment device.

6. The process of claim 5 wherein the using the length adjustment device further comprising a step of deactivating the length adjustment device.

7. The process of claim 5 wherein the first attachment device is a first loop formed by folding over the other first strap end upon itself.

8. The process of claim 5 wherein the second attachment device is a second loop formed by folding over the other second strap end upon itself.

9. The process of claim 5 wherein removably connecting second attachment device further comprises the step passing the other second strap end though a pass-through aperture formed by the boat fender.

10. The process of claim 9 wherein removably connecting second attachment device further comprises step of passing the first strap end through a second loop formed by second strap end.

11. A process of operating an adjustable tether system tether to removably connect a boat to a mooring device comprising the following steps:
(A) providing an adjustable tether system, the adjustable tether system comprises a first and second strap movable connected together by a length adjustment device that adjusts the overall length of the adjustable tether system, first strap has one first strap end that supports a first attachment device and a second first strap end fixedly attached to the length adjustment device, the second strap has one second strap end movably inserted into the length adjustment device and other second strap end that supports a second attachment device, the one first strap end is configured to removable connect to a vehicle such as a boat while other second strap end connects to mooring device;
(B) providing a boat;
(C) providing a mooring device;
(D) removably attaching first attachment device to the boat;
(E) removably connecting the second attachment device to the mooring device; and
(F) setting the length of the adjustable tether system using the length adjustment device.

12. The process of claim 11 wherein the using the length adjustment device further comprising a step of pulling second strap through the length adjustment device.

13. The process of claim 11 wherein the using the length adjustment device further comprising a step of moving a lever to rotate a cam out on contact with second strap.

14. The process of claim 11 wherein the first attachment device is a first loop formed by folding over the other first strap end upon itself.

15. The process of claim 11 wherein the second attachment device is a second loop formed by folding over the other second strap end upon itself.
